(19) United States
(12) Patent Application Publication
(10) Pub. No.: US 2026/0349620 A1
(43) Pub. Date: Nov. 5, 2026

(54) DATA INVERSION WITH REDUCED DELAY

(71) Applicant: Micron Technology, Inc., Boise, ID (US)

(72) Inventors: Woo Hyun Paik, Suwanee, GA (US); Kyubong Kong, Cupertino, CA (US)

(21) Appl. No.: 19/665,385

(22) Filed: May 1, 2026

Related U.S. Application Data
(60) Provisional application No. 63/800,049, filed on May 5, 2025.

(51) Int. Cl. G06F 3/06

(52) U.S. Cl. CPC G06F 3/0655; G06F 3/0604; G06F 3/0673

(57) ABSTRACT

The method includes sequentially receiving multiple sets of bits over respective portions of a burst segment and generating a preliminary inversion bit for each set based on a comparison between two consecutively received sets of bits. A first inversion bit corresponding to a first set of bits can be generated using the first preliminary inversion bit as an input through one or more logical operations. Substantially simultaneously, a portion of logical operations for generating a second inversion bit corresponding to a second set of bits can be performed using the second preliminary inversion bit as an input.

### PRIORITY INFORMATION

This application claims the benefits of U.S. Provisional Application Number 63/800,049, filed on May 5, 2025, the contents of which are incorporated herein by reference.

### TECHNICAL FIELD

The present disclosure relates generally to semiconductor memory and methods, and more particularly, to apparatuses, systems, and methods for data inversion with reduced delays.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, ferroelectric random access memory (FeRAM), and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system. A controller may be used to manage the transfer of data, commands, and/or instructions between the host and the memory devices.

### BRIEF DESCRIPTION OF THE DRAWINGS

FIG. 1 is a cross-sectional view of a system-in-package device in accordance with a number of embodiments of the present disclosure.

FIG. 2 is a block diagram of a computing system in accordance with a number of embodiments of the present disclosure.

FIG. 3 is a block diagram partially illustrating a data inversion process in accordance with a number of embodiments of the present disclosure.

FIG. 4 is a table illustrating data inversion process of different approaches.

FIG. 5 is a flow diagram corresponding to a method for performing data inversion with reduced delays in accordance with some embodiments of the present disclosure.

### DETAILED DESCRIPTION

Systems, apparatuses, and methods related to data inversion with reduced delays are described. A signal can be toggled to switch from one set of bits to a subsequent set of bits that are sequentially received (e.g., on set of DQs), particularly in a sequential access scheme. In this approach, a quantity of toggles that occurrs in accessing the memory can often be based on a quantity of particular data values to be switched (e.g., “0” to “1” or “1” to “0”) between two sets of bits, and each toggle results in an associated amount of power consumption. Therefore, an increased quantity of toggles can undesirably increase the power consumed in accessing the memory cells and it is desired to reduce the power consumption associated with sequentially accessing data within the computing system.

Some approaches have employed inversion schemes in which each inversion process conditionally inverts (e.g., flips) each bit of a current data set based on the number of transitions required when switching from a preceding data set to the present data set. Often, these inversion schemes are implemented in a cascaded manner, in which a later inversion process depends on the result of the preceding inversion process, such as through XOR computations. This sequential dependency can introduce an accumulating delay, particularly for the final inversion process, which must wait for all prior XOR-based inversion processes to complete before it can proceed. As a specific example, when eight inversion processes are performed as a unit, the final inversion process may be subject to a cumulative delay equivalent to eight sequential XOR computations.

This delay accumulation significantly impacts data access time (tAA) and increases timing skew across bit lanes. Further, these drawbacks of the inversion schemes can present challenges in meeting setup and hold timing constraints at high data rates, particularly under varying process, voltage, and temperature (PVT) conditions. The cascade structure may further worsen timing misalignment among inversion processes, leading to difficulties in maintaining data integrity and system stability in high-performance memory applications.

Aspects of the present disclosure address the above and other challenges by a data inversion (simply referred to as “inversion”) scheme that reduces calculation delay and mitigates skew among inversion processes. More particularly, embodiments of the present disclosure can leverage the Boolean Distributive Law to redistribute the XOR computations across at least partially parallelized architectures (as opposed to the cascaded architectures), thereby ensuring that each inversion process experiences a uniform and reduced computation delay. More particularly, in contrast to some approaches in which the last byte undergoes eight XOR delays, the proposed scheme ensures that each byte undergoes less than eight XOR delays (e.g., only four XOR delays), significantly reducing tAA and improving timing consistency across all byte lanes.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

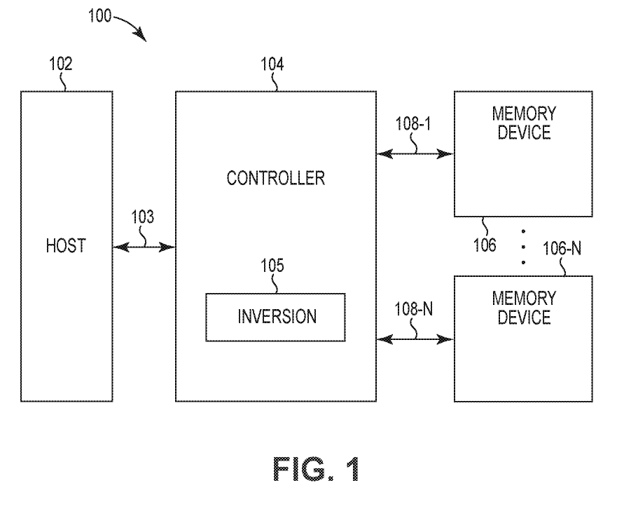

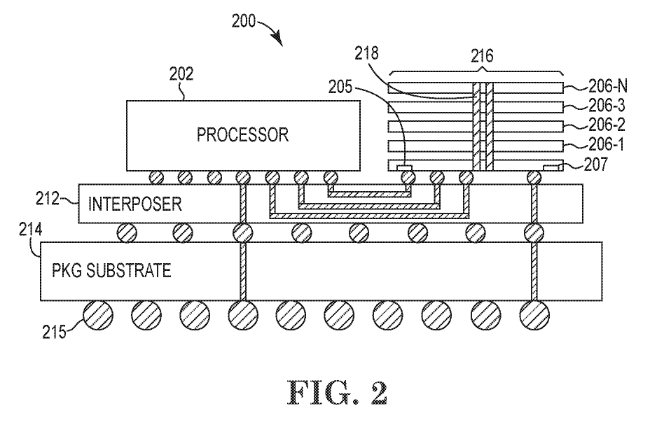

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Analogous elements within a Figure may be referenced with a hyphen and extra numeral or letter. See, for example, elements 106-1, …, 106-N in FIG. 2. Such analogous elements may be generally referenced without the hyphen and extra numeral or letter. For example, elements 106-1, …, 106-N may be collectively referenced as 106. As used herein, the designators “N”, “M”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a block diagram of a computing system 100 in accordance with a number of embodiments of the present disclosure. The computing system 100 includes a host 102, a controller 104, and memory devices 106-1, …, 106-N, which might also be separately considered an “apparatus.”

The computing system 100 can be a host system such as a personal laptop computer, a desktop computer, a digital camera, a smart phone, a memory card reader, and/or internet-of-thing enabled device, among various other types of hosts, and can include a memory access device (e.g., a processor and/or processing device). One of ordinary skill in the art will appreciate that “a processor” can intend one or more processors, such as a parallel processing system, a number of coprocessors, etc.

The system 100 can be, for instance, a server system and/or a high-performance computing (HPC) system and/or a portion thereof. As an example, the system 100 can be, for example, an HBM memory system (e.g., HBM2, HBM3, HBM4, etc.) with the memory devices 109 being stacked on a logic die (which can include controller 104) and interconnected via TSVs, with the stack and host 102 (e.g., processor) being co-located on an interposer coupled to a package substrate.

The host 102 can be a central processing unit (CPU), graphics processing unit (GPU), or system on a chip controller. As illustrated in FIG. 1, the host 102 can be coupled to the controller 104 via an interface 103. The interface 103 can be various types of communication paths, busses, or the like that allows for information to be transferred between the host 102 and the controller 104. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), Compute Express Link (CXL), or any other interface. The physical host interface can be used to transmit data between the host system 102 and the controller 104. The host system 102 can further utilize an NVM Express (NVMe) interface to access components (e.g., memory devices 109) when the memory system (e.g., including the controller 104) is coupled with the host system 102 by the PCIe interface. The physical host interface can provide an interface for passing control, address, data, and other signals between the memory system and the host system 102.

The controller 104 can control performance of memory operations for access commands (e.g., reads and writes) received from the host 102 and directed to one or more memory devices 106. The controller 104 can be coupled to the memory devices 106 via channels 108. The channels 108 can include various types data buses, such as a sixteen-pin data bus and a two-pin inversion bus, among other possible buses. In some embodiments, the channels 108 can be part of a physical (PHY) layer. As used herein, the term “PHY layer” generally refers to the physical layer in the Open Systems Interconnection (OSI) model of a computing system. The PHY layer may be the first (e.g., lowest) layer of the OSI model and can be used transfer data over a physical data transmission medium.

The memory device(s) 106 can provide main memory for the computing system 100 or could be used as additional memory or storage throughout the computing system 100. The memory devices 106 can be various/different types of memory devices. For instance, the memory device can include RAM, ROM, DRAM, SDRAM, PCRAM, RRAM, and flash memory, among others. In embodiments in which the memory device 106 includes persistent or non-volatile memory, the memory device 106 can be flash memory devices such as NAND or NOR flash memory devices, for example.

The memory devices 106 can each comprise a number of memory dies (e.g., dies 207, 206-1, …, 206-N illustrated in FIG. 2). These memory dies can be coupled (e.g., linked) to one another with the logic die (e.g., the logic die 207 shown in FIG. 2) located on a terminal side. In some embodiments, these linked memory dies can be “stacked” memory dies. Multiple stacked memory dies may form a High Bandwidth Memory (HBM) cube, where each memory dice is connected via through-silicon vias (TSVs) (e.g., TSVs 218 of FIG. 2).

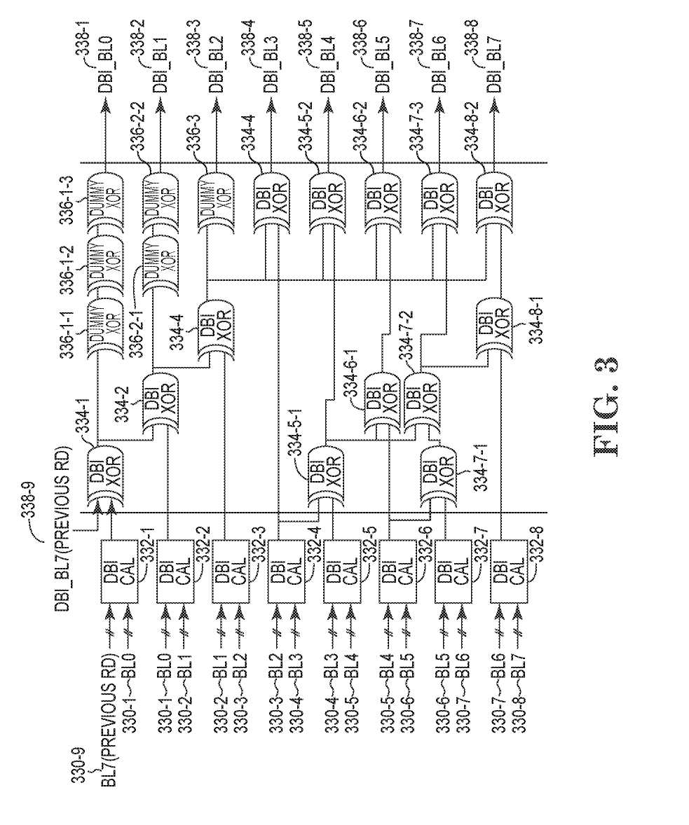

In the example shown in FIG. 1, the controller 104 includes an inversion component 105. Although not shown in FIG. 1 so as to not obfuscate the drawings, the inversion component 105 can include various circuitry to facilitate performance of operations described herein. For example, the inversion component 105 can perform those operations associated with performing inversion operations (alternatively referred to as a “data bus inversion operation”) on data prior to causing the data to be stored in the memory devices 106-1, …, 106-N. For example, the inversion component 105 can facilitate performance of operations associated with deciding whether to invent (e.g., perform an inversion operation on) each set of bits depending on a comparison with the preceding set of bits and performing inversion operations on those sets of bits based on the decisions previously made. Further details of the decision process are illustrated in connection with FIGS. 3-5.

FIG. 2 is a block diagram of an apparatus in the form of a computing system 200 including a memory package 216 including dies 207, 206-1, 206-2, 206-3, 206-N in accordance with a number of embodiments of the present disclosure. The secondary dies 206 receive commands, data, and/or other control signals from the primary die 207. The primary die 207 may also be referred to in the art as a base die, buffer die, interface die, or logic die. The secondary dies 206 may also be referred to in the art as memory dies.

In some embodiments, the primary die 207 does not provide memory for the memory package 216, whereas the secondary dies 206 do. Although not specifically illustrated, the secondary dies 206 can include memory banks, such as DRAM memory banks. In at least one embodiment, the secondary dies 206 do not include control logic (e.g., controller 104 shown in FIG. 1). Instead, the secondary dies 206 include terminals (e.g., command terminals, address terminals, data terminals, etc.) for being controlled by the primary die 207. The secondary dies 206 are coupled to the primary die 207 by through silicon vias (TSVs) 218. The secondary dies 206 are bonded to each other and to the primary die, the primary die is bonded to the interposer, which is also bonded to the processor 202 and to the substrate 214 by conductive connections 215, which may be referred to in the art as bumps or balls. The conductive connections 215 can pass signals, form terminals, provide ground connections, or merely serve as physical attachment points. Examples of the computing system 200 include high bandwidth memory (HBM), a hybrid memory cube (HMC), etc.

The primary die 207 receives commands, data, and/or other control signals via an interposer 212 from a processor 202 (e.g., CPU, GPU, or system on a chip controller, any of which may be referred to as a host or memory controller). The primary die 207 can decode commands and send them to the secondary dies 206 on a shared path via the TSVs 218. All or multiple of the secondary dies 206 can execute the commands. The inversion component 205, which may be analogous to the inversion component 105 shown in FIG. 1, can be located on the primary die 207.

In a number of embodiments, a read data flow is implemented in an HBM system utilizing Data Bus Inversion (DBI) to optimize power consumption and signal integrity. The process begins with determining (by the preliminary inversion circuits 332-1, …, 332-8 shown in FIG. 3) whether inversion should be applied to a given set of data bits. This determination is made based on a predefined criterion, such as reducing the number of bit transitions between the current and previous data sets to minimize power consumption and improve timing consistency.

Once the DBI calculation is performed, the processed data is forwarded to a data line (DQ) pointer, which directs the data toward a serialization unit. The serialization unit, which may be configured as an 8:1 serializer as an example, can compress multiple data bits into a serialized format for transmission through the memory interface. This serialized data can be then routed through a pre-driver and final driver, which prepare the signal for transmission by adjusting voltage levels and ensuring signal integrity.

FIG. 3 is a block diagram partially illustrating a data inversion (e.g., data bus inversion) process in accordance with a number of embodiments of the present disclosure. For example, FIG. 3 shows eight decision processes (simply referred to as “decisions” or alternatively referred to as “inversion decision”), in which a respective decision is made whether to perform an inversion operation on each set of bits 330-1, …, 330-8 (collectively referred to as “sets of bits 330”).

FIG. 3 shows eight sets of bits 330-1, …, 330-8 that can be sequentially and respectively received (e.g., transferred) via a number of data lines (DQs). For example, the set of bits 330-1 can be transferred via the DQs, followed by the set of bits 330-2 transferred via the DQs, followed by the set of bits 330-3 transferred via the DQs, followed by the set of bits 330-4 transferred via the DQs, followed by the set of bits 330-5 transferred via the DQs, followed by the set of bits 330-6 transferred via the DQs, followed by the set of bits 330-7 transferred via the DQs, and followed by the set of bits 330-8 transferred via the DQs.

Although embodiments are not so limited, the DQs via which sets of bits 330-1, …, 330-8 are transferred can include 8DQs, which allows each set of bits to include 8 bits. Although not shown in FIG. 3, the system (e.g., the computing system 100) can include 32 DQs which can be accompanied by 4 inversion buses (e.g., via which inversion bits are transferred). Accordingly, each inversion bus can be assigned to a set of DQs comprising 8 DQs (e.g., 32 DQs/4 inversion buses).

The DQs can be operated with a (e.g., predefined) burst length (e.g., a 8-bit burst length “BL”). A burst is a series of data transfers over multiple cycles, such as beats. As used herein, the term “beat” refers to a clock cycle increment during which an amount of data equal to the width of the memory bus may be transmitted. For example, 8-bit burst length can be made up of 8 beats of data transfers. Although embodiments are not so limited, a bus width corresponding to a size of each beat can be 4 (e.g., alternatively referred to as “x4”), 8 (e.g., alternatively referred to as “x8”), and/or 16 bits (e.g., alternatively referred to as “x16”).

Data transfers shown in FIG. 3 can be made during a particular burst segment of the predefined burst length. For example, the sets of bits 330 can be transferred over a (e.g., predefined) burst segment. Stated alternatively, the sets of bits 330-1, …, 330-8 are sequentially received over different portions of the burst segment.

As used herein, the term “burst segment” refers to a discrete portion of a burst length during which a specific subset of data “sharing” an inversion bus is transferred. For example, consider a computing system that includes 32 DQs and 4 inversion buses. In this system, the subsets of data (e.g., sets of bits 330-1, …, 330-8) transferred via each set of 8 DQs would share one specific inversion bus, which is for transferring a corresponding inversion bit that indicates the polarity of the data subset within that burst segment.

FIG. 3 shows eight preliminary inversion circuits 332-1, …, 332-8 (“DBI CAL” as shown in FIG. 3 and collectively referred to as preliminary circuits 332) that preliminarily make decisions on whether an inversion operation is to be performed on each set of bits 330-1, …, 330-8. For example, the preliminary circuit 332-1 makes a preliminary decision on whether to perform an inversion operation on the set of bits 330-1(“BL0” shown in FIG. 3) based on a comparison between the set of bits 330-9 (“BL7 (previous RD)” shown in FIG. 3) and 330-1. The set of bits 330-9 is analogous to the last set of bits transferred during the previous (e.g., preceding) burst segment.

Similarly, the preliminary circuit 332-2 makes a preliminary (e.g. initial) decision on whether to perform an inversion operation on the set of bits 330-2 (“BL1” shown in FIG. 3) based on a comparison between the sets of bits 330-1 and 330-2; the preliminary circuit 332-3 makes a preliminary decision on whether to perform an inversion operation on the set of bits 330-3 (“BL2” shown in FIG. 3) based on a comparison between the sets of bits 330-2 and 330-3; the preliminary circuit 332-4 makes a preliminary decision on whether to perform an inversion operation on the set of bits 330-4 (“BL3” shown in FIG. 3) based on a comparison between the sets of bits 330-3 and 330-4; the preliminary circuit 332-5 makes a preliminary decision on whether to perform an inversion operation on the set of bits 330-5 (“BL4” shown in FIG. 3) based on a comparison between the sets of bits 330-4 and 330-5; the preliminary circuit 332-6 makes a preliminary decision on whether to perform an inversion operation on the set of bits 330-6 (“BL5” shown in FIG. 3) based on a comparison between the sets of bits 330-5 and 330-6; the preliminary circuit 332-7 makes a preliminary decision on whether to perform an inversion operation on the set of bits 330-7 (“BL6” shown in FIG. 3) based on a comparison between the sets of bits 330-6 and 330-7; and the preliminary circuit 332-8 makes a preliminary decision on whether to perform an inversion operation on the set of bits 330-8 (“BL7” shown in FIG. 3) based on a comparison between the sets of bits 330-7 and 330-8.

In some embodiments, each preliminary circuit 332 makes a preliminary decision on whether inversion is to be performed on its respective set of bits 330 by determining (e.g., evaluating) if two input sets differ by more than a threshold quantity of bits. For example, assuming that each set consists of eight bits, the preliminary circuit 332 can indicate the need for inversion on the respective set if the two input sets differ by more than four bits. Each preliminary circuit 332 can include combinational logic, although embodiments are not so limited.

The output of each preliminary circuit 332 indicates a preliminary (e.g., initial) decision on whether inversion is to be performed on the respective set of bits 330. For example, the output of the preliminary circuit 332-1 indicates a preliminary decision on whether inversion is to be performed on the set of bits 330-1. The outputs of preliminary circuit 332-1, …, 332-8 can be respectively provided to one or more XOR gates for finalizing the decision on whether inversion is to performed on each set of bits 330.

These XOR gates can be of various types of XOR gates, such as XOR gates 334 (“DBI XOR” as shown in FIG. 3) and XOR gates 336 (“DUMMY XOR” as shown in FIG. 3). For example, XOR gates 334 performs an XOR operation (alternatively referred to as an “XOR computation”) using respective two inputs, while the XOR gates 336 simply output the inputs as is.

As an example, as shown in FIG. 3, the decision process for the set of bits 330-1 involves performing an XOR operation (alternatively referred to as “XORing”) at XOR gate 334-1 using an output (“DBI_BL7” 338-9) of the preceding decision process and the outputs of the preliminary circuits 332-1. The output of XOR gate 334-1 is then sequentially fed (e.g., input) into XOR gates 336-1-1, 336-1-2, and 336-1-3, with the final output (“DBI_BL0” shown in FIG. 3) remaining the same as that of XOR gate 334-1.

As an example, as shown in FIG. 3, the decision process for the set of bits 330-2 involves performing an XOR operation at XOR gate 334-2 using outputs of the XOR gate 334-1 and the preliminary circuit 332-2. The output of XOR gate 334-2 is then sequentially fed (e.g., input) into XOR gates 336-2-1 and 336-2-2, with the final output (“DBI_BL1” shown in FIG. 3) remaining the same as that of XOR gate 334-2.

As an example, as shown in FIG. 3, the decision process for the set of bits 330-3 involves performing an XOR operation at XOR gate 334-3 using outputs of the XOR gate 334-2 and the preliminary circuit 332-3. The output of XOR gate 334-3 is then sequentially fed (e.g., input) into XOR gate 336-3, with the output (“DBI_BL2” shown in FIG. 3) of the XOR gate 336-3 remaining the same as that of XOR gate 334-3.

These “dummy” XOR gates 336-1-1, 336-1-2, 336-1-3, 336-2-1, 336-2-2, and 336-3 are used to align the timing of outputs 338-1, 338-2, and 338-3 with the other outputs 338-4 through 338-8 from the remaining decision processes. For example, dummy XOR gates 336-1-1, 336-1-2, and 336-1-3 introduce a delay equivalent to three XOR computations; dummy XOR gates 336-2-1 and 336-2-2 introduce a delay equivalent to two XOR computations; and dummy XOR gate 336-3 introduces a delay equivalent to one XOR computation. These delays collectively align the timing of outputs that are generated after a delay equivalent to four XOR computations across the eight decision processes.

As an example, as shown in FIG. 3, the decision process for set 330-4 involves performing an XOR operation at XOR gate 334-4 using the outputs of XOR gate 334-3 and preliminary circuit 332-4, with the final output being the output of XOR gate 334-4 (“DBI_BL4” shown in FIG. 3). As an example, as shown in FIG. 3, the decision process for the set of bits 330-5 involves performing a first XOR operation at the XOR gate 334-5-1 using outputs of the preliminary circuits 332-4 and 332-5 and a second XOR operation at the XOR gate 334-5-2 using outputs of the XOR gates 334-3 and 334-5-1, with the final output being the output of the XOR gate 334-5-2 (“DBI_BL5” shown in FIG. 3).

As an example, as shown in FIG. 3, the decision process for the set of bits 330-5 involves performing a first XOR operation at the XOR gate 334-5-1 using outputs of the preliminary circuits 332-4 and 332-5 and a second XOR operation at the XOR gate 334-5-2 using outputs of the XOR gates 334-3 and 334-5-1, with the final output being the output of the XOR gate 334-5-2 (“DBI_BL5” shown in FIG. 3). As an example, as shown in FIG. 3, the decision process for the set of bits 330-6 involves performing a first XOR operation at the XOR gate 334-6-1 using outputs of the XOR gate 334-5-1 and the preliminary circuits 332-5 and a second XOR operation at the XOR gate 334-6-2 using outputs of the XOR gates 334-3 and 334-6-1, with the final output being the output of the XOR gate 334-6-2 (“DBI_BL5” shown in FIG. 3).

As an example, as shown in FIG. 3, the decision process for the set of bits 330-7 involves performing a first XOR operation at the XOR gate 334-7-1 using outputs of the preliminary circuits 332-6 and 332-7, a second XOR operation at the XOR gate 334-7-2 using outputs of the XOR gates 334-5-1 and 334-7-1, and a third XOR operation at the XOR gate 334-7-3 using outputs of the XOR gates 334-3 and 334-7-2, with the final output being the output of the XOR gate 334-7-3 (“DBI_BL6” shown in FIG. 3). As an example, as shown in FIG. 3, the decision process for the set of bits 330-8 involves performing a first XOR operation at the XOR gate 334-8-1 using outputs of the XOR gate 334-7-2 and the preliminary circuits 332-8 and a second XOR operation at the XOR gate 334-8-2 using outputs of the XOR gates 334-3 and 334-8-1, with the final output being the output of the XOR gate 334-8-2 (“DBI_BL7” shown in FIG. 3).

While an output from each preliminary circuit 332 can be a preliminary indication of a polarity of the respective set of bits, each output 338-1, …, 338-8 (alternatively referred to as a “flag”, an “inversion bit”, or “inversion information”) of the respective decision process can be a final indication of a polarity of the respective set of bits. As used herein, the term “polarity” refers to an indication of whether a respective set of bits has been inverted or remains in its original state. More specifically, polarity represents the logical state associated with a data set, where a first polarity (e.g., “normal” or “0”) may indicate that the data is unchanged, while a second polarity (e.g., “inverted” or “1”) may indicate that the bits have been flipped. The controller (e.g., the controller 104) can perform an inversion operation on each set of bits based on the respective polarity (as determined by the respective output 338-1, …, 338-8), which indicates whether the set of bits should be (e.g., is to be) inverted.

The eight decision processes shown in FIG. 3 can be performed over four sequential phases. For example, XOR computations can be substantially simultaneously (e.g., in parallel) performed at XOR gates 334-1, 334-5-1, and 334-7-1 during the first phase; XOR computations can be substantially simultaneously performed at XOR gates 334-2, 334-6-1, 334-7-2 during the second phase; XOR computations can be substantially simultaneously performed at XOR gates 334-3, 334-8-1 during the third phase; and XOR computations can be substantially simultaneously performed at XOR gates 334-4, 334-5-2, 334-6-2, 334-7-3, and 334-8-2 during the fourth phase. Alternatively speaking, the XOR computations performed during the first phase are performed prior to the XOR computations performed during the second phase; the XOR computations performed during the second phase are performed prior to the XOR computations performed during the third phase; and the XOR computations performed during the third phase are performed prior to the XOR computations performed during the fourth phase. Each phase can correspond to a delay equivalent to a single XOR computation.

As used herein, the term “substantially” means that the characteristic need not be absolute, but is close enough so as to achieve the advantages of the characteristic. For example, “substantially simultaneously” is not limited to operations that are performed absolutely simultaneously and can include timings that are intended to be simultaneously but due to manufacturing limitations may not be precisely simultaneously.

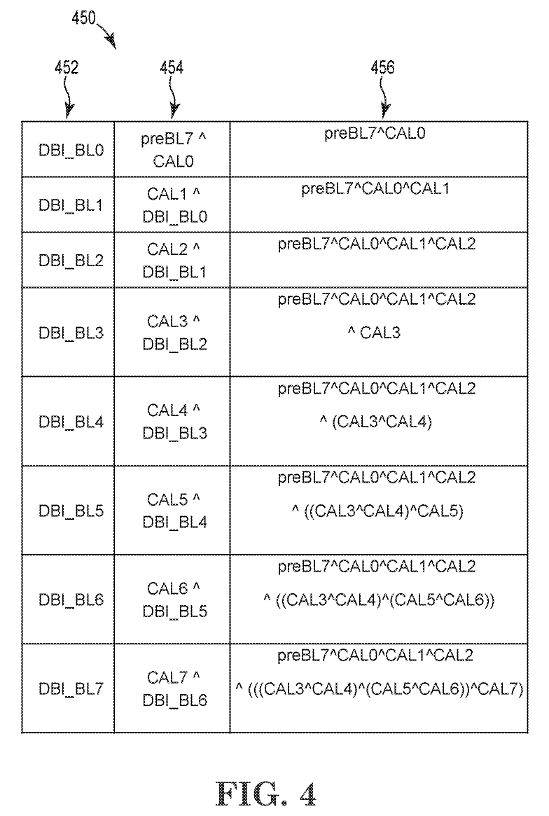

FIG. 4 is a table illustrating data inversion process of different approaches. A column 454 illustrates eight decision processes performed in some approaches, in which the decision is made on whether to perform an inversion operation on each set of bits (e.g., set of bits 330-1, …, 330-8 shown in FIG. 3) in a cascaded manner, where a later decision process solely depends on the result of the preceding decision process. The symbol “^” shown in FIG. 4 represents an XOR operation and/or computing between two values. For example, “CAL1 ^ DBI_BL0” represents XORing (e.g., performing an XOR operation on) two respective values “CAL1” and “DBI_BL0”.

For example, a decision process to generate “DBI_BL0” for a first set of bits involves XORing a preliminary bit “CAL0” (preliminarily indicative of a polarity of the first set of bits) and an inversion bit (“preBL7” as shown in FIG. 4) of a preceding set of bits; a decision process to generate “DBI_BL1” for a second set of bits involves XORing a preliminary bit “CAL1” (preliminarily indicative of a polarity of the second set of bits) and an inversion bit of the first set of bits “DBI_BL0”; a decision process to generate “DBI_BL2” for a third set of bits involves XORing a preliminary bit “CAL2” (preliminarily indicative of a polarity of the third set of bits) and an inversion bit of the second set of bits “DBI_BL1”; a decision process to generate “DBI_BL3” for a fourth set of bits involves XORing a preliminary bit “CAL3” (preliminarily indicative of a polarity of the fourth set of bits) and an inversion bit of the third set of bits “DBI_BL2”; a decision process to generate “DBI_BL4” for a fifth set of bits involves XORing a preliminary bit “CAL4” (preliminarily indicative of a polarity of the fifth set of bits) and an inversion bit of the fourth set of bits “DBI_BL3”; a decision process to generate “DBI_BL5” for a sixth set of bits involves XORing a preliminary bit “CAL5” (preliminarily indicative of a polarity of the sixth set of bits) and an inversion bit of the fifth set of bits “DBI_BL4”; a decision process to generate “DBI_BL6” for a seventh set of bits involves XORing a preliminary bit “CAL6” (preliminarily indicative of a polarity of the seventh set of bits) and an inversion bit of the sixth set of bits “DBI_BL5”; and a decision process to generate “DBI_BL7” for an eighth set of bits involves XORing a preliminary bit “CAL7” (preliminarily indicative of a polarity of the eight set of bits) and an inversion bit of the seventh set of bits “DBI_BL6”.

A column 456 illustrates eight decision processes performed in accordance with various embodiments of the present disclosure and in which the decision is made on whether to perform an inversion operation on each set of bits (e.g., set of bits 330-1, …, 330-8 shown in FIG. 3). For example, eight decision processes shown in column 456 are analogous to those eight decision processes respectively to generate inversion bits 338-1, …, 338-8 (“DBI_BL0”, …, “DBI_BL7” shown in FIG. 3) as described in connection with FIG. 3.

A column 452 represents eight inversion information, “DBI_BL0”, …, “DBI_BL7” as a result of the decision processes performed respectively in columns 454 and 456, respectively. Each inversion bit generated by respective processes on columns 454 and 456 are equivalent to one another. For example, an inversion bit “DBI_BL0”, …, “DBI_BL7” generated by the processes described in column 454 are respectively equivalent to an inversion bit “DBI_BL0”, …, “DBI_BL7” generated by the processes described in column 456.

Embodiments of the present disclosure leverage the Boolean Distributive Law to redistribute XOR computations such that the computation of one inversion bit does not necessarily need to wait for the inversion bit of a preceding set of bits to become available. For example, consider the process of generating an inversion bit “DBI_BL7” in the manner described over the rows corresponding to column 454. In this example, “DBI_BL7” can only be generated once “DBI_BL6” becomes available, which itself must undergo seven preceding XOR computations before being determined. Consequently, “DBI_BL7” may only become available after a delay equivalent to at least eight XOR computations.

In contrast, embodiments of the present disclosure rearrange the XOR computations using the Boolean Distributive Law such that each inversion bit can be computed without waiting for the final result of the preceding byte’s inversion bit. This parallel or near-parallel arrangement eliminates the requirement that “DBI_BL7” must follow the complete evaluation of “DBI_BL6” and all of its prior XOR stages. Instead, partial XOR results can be shared or aggregated so that each byte (including BL7) relies on fewer sequential operations, thereby reducing the overall delay from eight or more XOR computations to a smaller, uniform path depth.

As a specific example, consider an example process of generating an inversion bit “DBI_BL4” shown in FIG. 4 (e.g., the inversion bit 338-5 shown in FIG. 3). According to the process described in column 454, generating “DBI_BL4” would require waiting until “DBI_BL3” is available, thereby introducing a sequential dependency that delays the computation of “DBI_BL4.”

In contrast, the approach described in column 456 eliminates the need for this waiting period by leveraging the Boolean Distributive Law. Specifically, an XOR computation involving “CAL3” and “CAL4” can be performed before “DBI_BL3” is available. This computation, when combined with another XOR computation (e.g., “preBL7^CAL0^CAL1^CAL2” performed at XOR gate 334-5-2 shown in FIG. 3) forms a set of operations that is functionally equivalent to computing “CAL4” XOR “DBI_BL3.” This reordering (according to the Boolean Distributive Law) still allows the inversion bit “DBI_BL4” to be determined without waiting for the complete computation of “DBI_BL3,” thereby reducing the overall delay and mitigating the sequential dependency.

By reordering the XOR computations based on the Boolean Distributive Law, the inversion bit “DBI_BL4” is determined independently rather than waiting for the full computation of “DBI_BL3.” This means that operations typically dependent on “DBI_BL3” are performed concurrently through partial XOR computations, thereby shortening the computation path.

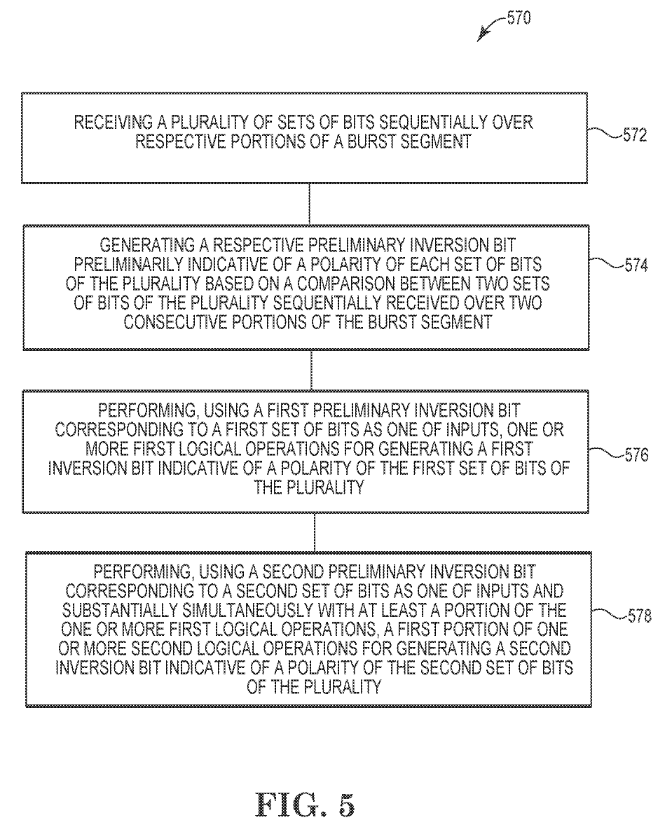

FIG. 5 is a flow diagram corresponding to a method for performing data inversion with reduced delays in accordance with some embodiments of the present disclosure. The method 570 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 570 is performed by the controller 104 and/or the logic die 207 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 572, a plurality of sets of bits (e.g., the sets of bits 330-1, …, 330-8 shown in FIG. 3) can be received sequentially over respective portions of a burst segment (e.g., “BL1” to “BL7” shown in FIG. 3). At 574, a respective preliminary inversion bit (preliminarily indicative of a polarity of each set of bits of the plurality) can be generated (at the respective preliminary circuit 332-1, …, 332-8) based on a comparison between two sets of bits of the plurality sequentially received over two consecutive portions of the burst segment.

At 576, one or more first logical operations (e.g., performed by a set of logic gates 334-5-1, 334-5-2, a set of logic gates, 334-6-1, 334-6-2, a set of logic gates, 334-7-1, 334-7-2, 334-7-2, or a set of logic gates, 334-8-1, 334-8-2) can be performed for generating a first inversion bit (e.g., inversion bits 338-4, …, 338-8 shown in FIG. 3) indicative of a polarity of a first set of bits of the plurality (e.g., the sets of bits 330-5, …, 330-8 shown in FIG. 3). The first logical operations can be performed using a first preliminary inversion bit corresponding to the first set of bits as one of inputs.

At 578, a first portion of one or more second logical operations can be performed (e.g., at the XOR gates 334-6-1, 334-7-1, 334-7-2) for generating a second inversion bit indicative of a polarity of a second set of bits (e.g., the set of bits 330-5, …, 330-8) of the plurality. The second logical operations can be performed using a second preliminary inversion bit corresponding to the second set of bits as one of inputs and substantially simultaneously with at least a portion of the one or more first logical operations. In some embodiments, a second portion of the one or more second logical operations can be performed using a result of the at least the portion of the first one or more logical operations as at least one of inputs.

In some embodiments, the first set of bits can be received during a first portion (“BL4”, “BL5”, or “BL6”, shown in FIG. 3) of the burst segment and prior to the second set of bits received during a second portion (“BL5”, “BL6”, or “BL7” shown in FIG. 3) of the burst segment. In this example, a second portion of the one or more second logical operations can be performed (e.g., at the XOR gates 334-6-1, 334-7-1, 334-7-2) prior to another portion of the one or more first logical operations.

In some embodiments, a respective inversion bit for each set of bits of a first portion (e.g., the set of bits 330-1, …, 330-4) of the plurality of sets of bits can be generated. This can be generated based on a comparison between a preliminary inversion bit (preliminarily indicative of a polarity of a set of bits received during a respective portion of the burst segment) and an inversion bit (indicative of a polarity of a set of bits received during a preceding portion of the burst segment). In this example, the first set of bits and the second set of bits can be part of a second portion (e.g., the set of bits 330-5, …, 330-8) of the plurality of sets of bits.

In some embodiments, a respective inversion bit can be generated for at least one set of bits (e.g., set of bits 330-5 or 330-7) of the second portion of the plurality of sets of bits based at least in part on a comparison between preliminary inversion bits (preliminary indicative of respective polarities of two sets of bits received over two consecutive portions of the burst segment). In some embodiments, an inversion operation on the first set of bits can be performed based on the polarity indicated by the first inversion bit. Further, an inversion operation on the second set of bits can be performed based on the polarity indicated by the second inversion bit.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a plurality of sets of bits sequentially over respective portions of a burst segment;
generating a respective preliminary inversion bit preliminarily indicative of a polarity of each set of bits of the plurality based on a comparison between two sets of bits of the plurality sequentially received over two consecutive portions of the burst segment;
performing, using a first preliminary inversion bit corresponding to a first set of bits as one of inputs, one or more first logical operations for generating a first inversion bit indicative of a polarity of the first set of bits of the plurality; and
performing, using a second preliminary inversion bit corresponding to a second set of bits as one of inputs and substantially simultaneously with at least a portion of the one or more first logical operations, a first portion of one or more second logical operations for generating a second inversion bit indicative of a polarity of the second set of bits of the plurality.

2. The method of claim 1, further comprising performing, using a result of the at least the portion of the first one or more logical operations as at least one of inputs, a second portion of the one or more second logical operations.

3. The method of claim 1, wherein:
the first set of bits is received during a first portion of the burst segment and prior to the second set of bits received during a second portion of the burst segment; and
the method further comprises performing a second portion of the one or more second logical operations prior to another portion of the one or more first logical operations.

4. The method of claim 1, further comprises:
generating a respective inversion bit for each set of bits of a first portion of the plurality of sets of bits based on a comparison between:
a preliminary inversion bit preliminarily indicative of a polarity of a set of bits received during a respective portion of the burst segment; and
an inversion bit indicative of a polarity of a set of bits received during a preceding portion of the burst segment;
wherein the first set of bits and the second set of bits are part of a second portion of the plurality of sets of bits.

5. The method of claim 4, further comprising:
generating a respective inversion bit for at least one set of bits of the second portion of the plurality of sets of bits based at least in part on a comparison between preliminary inversion bits preliminary indicative of respective polarities of two sets of bits received over two consecutive portions of the burst segment.

6. The method of claim 1, further comprising:
performing an inversion operation on the first set of bits based on the polarity indicated by the first inversion bit; and
performing an inversion operation on the second set of bits based on the polarity indicated by the second inversion bit.

7. An apparatus, comprising:
a plurality of sets of logic gates, each set of logic gates configured to perform one or more respective logical operations to generate a respective inversion bit indicative of a polarity of each set of bits of a plurality of sets of bits sequentially received over portions of a burst segment;
wherein:
a first set of logic gates of a first portion of the plurality of sets of logic gates is configured to perform a respective first logical operation using, as respective inputs:
a first preliminary inversion bit preliminarily indicative of a polarity of a first set of bits; and
a preliminary inversion bit preliminarily indicative of a polarity of a set of bits received prior to the first set of bits; and
a second set of logic gates of the first portion is configured to perform a respective first logical operation using, as respective inputs:
a second preliminary inversion bit preliminarily indicative of a polarity of a second set of bits; and
a result of the respective first logical operation performed at the first set of logic gates as one of its inputs.

8. The apparatus of claim 7, wherein a third set of logic gates of the first portion is configured to perform a respective first logical operation using, as respective inputs:
the second preliminary inversion bit; and
a third preliminary inversion bit preliminarily indicative of a polarity of a third set of bits.

9. The apparatus of claim 8, wherein the third set of logic gates of the first portion is further configured to perform a respective subsequent logical operation using, as respective inputs:
a result of the respective first logical operation performed at the first set of logic gates; and
a result of the respective first logical operation performed at the third set of logic gates.

10. The apparatus of claim 9, wherein the third set of logic gates of the first portion is further configured to perform another respective subsequent logical operation using, as one of its puts:
a result of the respective subsequent logical operation performed at the third set of logic gates, wherein a result of the respective subsequent operation performed at the third set of logic gates corresponds to a third inversion bit indicative of a polarity of the third set of bits.

11. The apparatus of claim 9, wherein a fourth set of logic gates of the first portion is configured to perform a respective first logical operation using as respective inputs:
a result of the respective subsequent logical operation performed at the third set of logic gates; and
a fourth preliminary inversion bit preliminarily indicative of a polarity of a fourth set of bits.

12. The apparatus of claim 11, wherein the fourth set of logic gates of the first portion is configured to perform a respective subsequent operation using, as respective inputs:
a result of the respective subsequent operation performed at the third set of logic gates; and
a result of the respective first logical operation performed at the fourth set of logic gates, wherein a result of the respective subsequent operation performed at the fourth set of logic gates corresponds to a fourth inversion bit indicative of a polarity of the fourth set of bits.

13. The apparatus of claim 7, wherein each set of logic gates of a second portion of the plurality of sets of logic gates is configured to perform a respective first logical operation using, as respective inputs:
a preliminary inversion bit preliminarily indicative of a polarity of a set of bits received during a respective portion of the burst segment; and
an inversion bit indicative of a polarity of a set of bits received during a preceding portion of the burst segment, wherein a result of the respective first logical operation corresponds to an inversion bit indicative of a polarity of the set of bits received during the respective portion of the burst segment.

14. The apparatus of claim 13, wherein the first set of logic gates is configured to perform a respective subsequent logical operation using, as one of its inputs:
a result of the respective first logical operation performed at the first set of logic gates, wherein a result of the respective subsequent operation performed at the first set of logic gates corresponds to a first inversion bit indicative of a polarity of the first set of bits.

15. The apparatus of claim 13, wherein the second set of logic gates is configured to perform a respective subsequent logical operation using, as one of its inputs:
a result of the respective first logical operation performed at the second set of logic gates, wherein a result of the respective subsequent operation performed at the second set of logic gates corresponds to a second inversion bit indicative of a polarity of the second set of bits.

16. The apparatus of claim 7, wherein at least one logical operation of the one or more respective logical operations is an XOR operation.

17. An apparatus, comprising:
a plurality of sets of logic gates, each set of logic gates configured to perform one or more logical operations to generate a respective inversion bit indicative of a polarity of each set of bits of a plurality of sets of bits sequentially received over portions of a burst segment;
wherein a first set of logic gates of the plurality is configured to perform, using a first preliminary inversion bit corresponding to a first set of bits as one of inputs, one or more first logical operations to generate a first inversion bit indicative of a polarity of the first set of bits of the plurality; and
wherein a second set of logic gates of the plurality is configured to perform, using a second preliminary inversion bit corresponding to a second set of bits as one of inputs and substantially simultaneously with at least a portion of the one or first more logical operations, a first portion of one or more second logical operations to generate a second inversion bit indicative of a polarity of the second set of bits of the plurality.

18. The apparatus of claim 17, wherein the second set of logic gates is configured to perform the first portion of the one or more second logical operations prior to another portion of the one or more first logical operations.

19. The apparatus of claim 17, further comprising a plurality of preliminary inversion circuits, wherein each preliminary inversion circuit of the plurality is configured to compare, to generate a respective preliminary inversion bit for each set of bits of the plurality:
a set of bits received during a respective portion of the burst segment; and
a set of bits received during a preceding portion of the burst segment.

20. The apparatus of claim 17, wherein at least one of logic gates of the plurality of sets of logic gates is an XOR gate.
